(19) United States
(12) Patent Application Publication
(10) Pub. No.: US 2018/0078024 A1
(43) Pub. Date: Mar. 22, 2018

(54) NECK STRAP STRUCTURE

(71) Applicant: Tienchi HU, Taipei (TW)

(72) Inventor: Tienchi HU, Taipei (TW)

(21) Appl. No.: 15/814,683

(22) Filed: Nov. 16, 2017

Related U.S. Application Data
(63) Continuation-in-part of application No. 14/981,099, filed on Dec. 28, 2015.
(60) Provisional application No. 62/200,860, filed on Aug. 4, 2015.

(51) Int. Cl. A45F 5/00; A45F 3/04; G03B 17/56

(52) U.S. Cl. CPC A45F 5/00; A45F 2005/006; G03B 17/561; A45F 3/04

(57) ABSTRACT

A neck strap structure supporting an article and used with a loaded object having at least one shoulder strap is provided. The neck strap structure includes a neck strap body and an auxiliary member. The neck strap body has a contact part wherein two ends of the neck strap body are connected to the article. The auxiliary member includes a first auxiliary part and a second auxiliary part separate from the first auxiliary part. The first auxiliary part is coupled to the contact part of the neck strap body, and the second auxiliary part is detachably coupled to the loaded object. The first auxiliary part includes a first fastener and the second auxiliary part includes a second fastener corresponding to the first fastener. A stress exerted by the neck strap body is diverted from a neck of the user to the loaded object.

### CROSS-REFERENCE TO RELATED APPLICATIONS

The present application is a continuation-in-part application claiming benefit from a pending U.S. patent application Ser. No. 14/981,099 and filed Dec. 28, 2015, claiming benefit from a prior-filed provisional application bearing a Ser. No. 62/200,860 and filed Aug. 4, 2015, the entity of which is incorporated herein for reference.

### FIELD OF THE INVENTION

The present invention relates to a neck strap structure and an auxiliary member thereof, and more particularly to a neck strap structure for carrying a camera and an auxiliary member thereof.

### BACKGROUND OF THE INVENTION

FIG. 1 schematically illustrates the usage of a conventional camera strap. As shown in FIG. 1, a camera body 10 is hung around a user's neck through a strap 11. However, the use of the strap 11 still has some drawbacks. For example, a main body and a lens module of a single-lens reflex camera have a total weight up to 2 kilograms. If the single-lens reflex camera is hung around the user's neck for a long time, the single-lens reflex camera becomes a heavy burden on the user and the user usually feels uncomfortable.

Therefore, there is a need to provide a novel neck strap structure in order to overcome the above drawbacks.

### SUMMARY OF THE INVENTION

The present disclosure provides a neck strap structure for alleviating the discomfort of carrying the neck-hanging article.

In accordance with an aspect of the present invention, there is provided a neck strap structure supporting an article and used with a loaded object having at least one shoulder strap. The neck strap structure includes a neck strap body and an auxiliary member. The neck strap body has a contact part wherein two ends of the neck strap body are connected to the article. The auxiliary member includes a first auxiliary part and a second auxiliary part separate from the first auxiliary part. The first auxiliary part is coupled to the contact part of the neck strap body. The second auxiliary part is detachably coupled to the loaded object. The first auxiliary part includes a first fastener, and the second auxiliary part includes a second fastener corresponding to the first fastener.

In an embodiment, the first auxiliary part of the auxiliary member is fixed on the neck strap body by a stitching means, a gluing means or a snap-fit means, or the first auxiliary part of the auxiliary member is integrally formed with the neck strap body. In another embodiment, two ends of the first auxiliary part are connected together to surround the contact part of the neck strap body, and the first auxiliary part is slidable along the neck strap body.

In an embodiment, the loaded object has a hang ring or a handle, wherein the second auxiliary part of the auxiliary member is detachably coupled to the hang ring or the handle.

In an embodiment, two ends of the second auxiliary part are connected together to surround a portion of the hang ring or the handle, and the second auxiliary part is slidable along the hang ring or the handle.

In an embodiment, the first fastener and the second fastener are magnetic fasteners which attract each other.

In an embodiment, the first fastener is a male magnetic fastener, and the second fastener is a female magnetic fastener.

In an embodiment, the female magnetic fastener has a groove connected to a central recess of the female magnetic fastener.

In an embodiment, the first fastener is a male snap fastener, and the second fastener is a female snap fastener, and vice verse.

In accordance with another aspect of the present invention, there is provided a neck strap structure. The neck strap structure includes a strap body and an auxiliary member. The strap body has a contact part wherein two ends of the strap body are connected to the article. A first end of the auxiliary member is coupled to the contact part of the neck strap body, and a second end of the auxiliary member is detachably and slidably coupled to the handle of the backpack.

In an embodiment, the first end of the auxiliary member is fixed on the neck strap body by a stitching means, a gluing means or a snap-fit means, or the first end of the auxiliary member is integrally formed with the neck strap body.

In an embodiment, the first end of the auxiliary member has a first collar, and the first collar is slidably coupled to the contact part of the neck strap body.

In an embodiment, the first end of the auxiliary member has at least one set of snap fasteners to make ends of the first collar to be attached together to form the first collar at the first end of the auxiliary member.

In an embodiment, the second end of the auxiliary member has a second collar, which is formed by attaching ends of the second collar via one or more sets of snap fasteners.

In an embodiment, the second end of the auxiliary member has a hook slidably catching the handle of the backpack.

In an embodiment, the second end of the auxiliary member has a hook with a latch, wherein the hook slidably catches the handle of the backpack.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 schematically illustrates the usage of a conventional camera strap;

FIG. 2A schematically illustrates the structure and the outer appearance of an auxiliary member for a camera strap according to the present disclosure;

FIG. 2B schematically illustrates the connection between the camera strap and a loaded object through the auxiliary member;

FIG. 3 schematically illustrates a neck strap structure according to an embodiment of the present disclosure;

FIG. 4 schematically illustrates a neck strap structure according to another embodiment of the present disclosure;

FIG. 5 schematically illustrates a neck strap structure according to a further embodiment of the present disclosure;

FIG. 6 schematically illustrates a neck strap structure according to a further embodiment of the present disclosure;

FIGS. 7A˜7C schematically illustrate some other examples of the neck strap structure according to the present disclosure;

FIG. 8 schematically illustrates a neck strap structure according to a further embodiment of the present disclosure; and

FIG. 9 schematically illustrates the magnetic fasteners of FIG. 8.

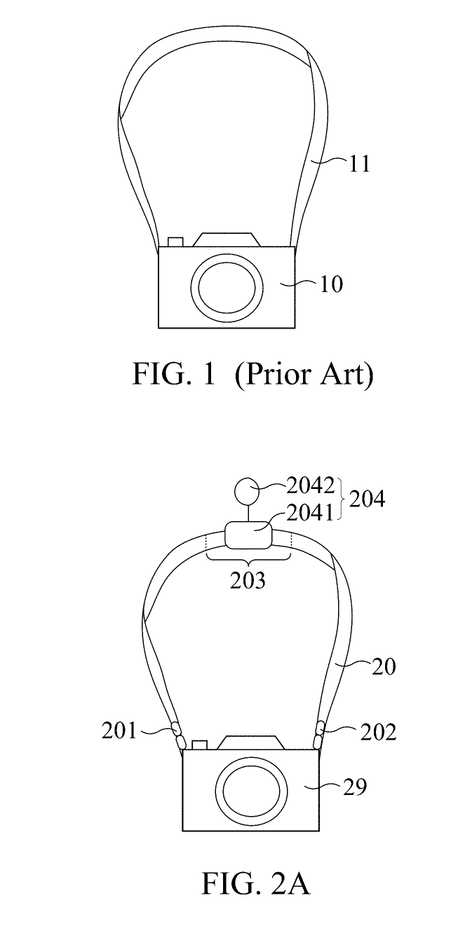

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

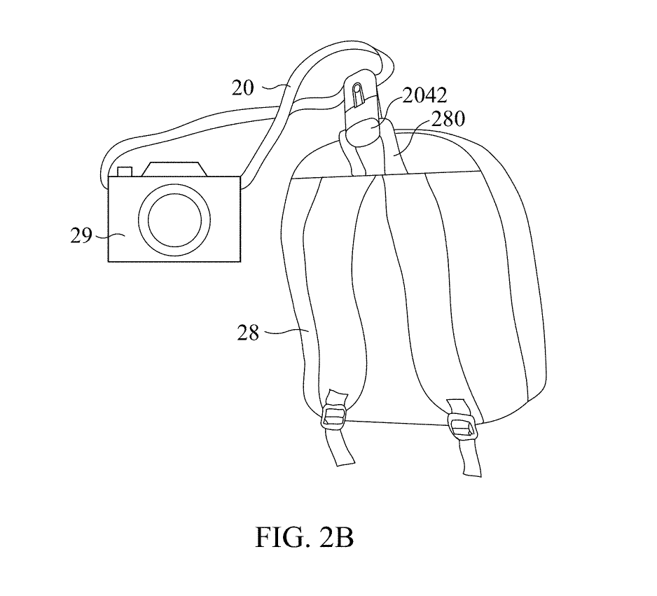

FIG. 2A schematically illustrates the structure and the outer appearance of an auxiliary member for a camera strap in order to overcome the drawbacks of the conventional technologies. As shown in FIG. 2A, a first end 201 and a second end 202 of a neck strap body 20 are fixed on a camera 29. The fixing means are well known to those skilled in the art, and are not redundantly described herein. For alleviating the oppression of the conventional strap on the neck, the camera strap is additionally equipped with an auxiliary member 204. The auxiliary member 204 is located at a contact part 203 of the neck strap body 20, wherein the contact part 203 is in contact with the user's neck. A first end 2041 of the auxiliary member 204 is coupled to the contact part 203 of the neck strap body 20. A second end 2042 of the auxiliary member 204 has a detachable fastening element. The detachable fastening element is coupled with an object loaded by the user. Consequently, the stress originally applied to the user's neck will be diverted to the loaded object. It is noted that the width of the contact part 203 is not restricted. The width of the contact part 203 shown in the drawing is presented herein for purpose of illustration and description only.

FIG. 2B schematically illustrates the connection between the camera strap and a loaded object through the auxiliary member. For example, the loaded object is a double-shoulder backpack 28. When the user wears the double-shoulder backpack 28, the detachable fastening element at the second end 2042 of the auxiliary member 204 is coupled to a handle 280 of the double-shoulder backpack 28. Of course, the detachable fastening element at the second end 2042 of the auxiliary member 204 may be coupled to a similar part (e.g., a hang ring or a hook) of the double-shoulder backpack 28. Consequently, the stress originally exerted by the neck strap body 20 will be diverted from the user's neck to the user's body where the neck strap body 20 and the two shoulder straps of the double-shoulder backpack 28 are in contact with. In such way, the discomfort of carrying the camera strap can be effectively alleviated. That is, the neck strap structure of the present disclosure is advantageous over the conventional neck strap structure. In this embodiment, the loaded object is a double-shoulder backpack 28. In some other embodiments, the loaded object includes another type of backpack, for example a single-shoulder backpack (sling backpack).

The present invention provides a neck strap structure including an auxiliary member. Hereinafter, some examples of the neck strap structure including the auxiliary member will be illustrated in more details.

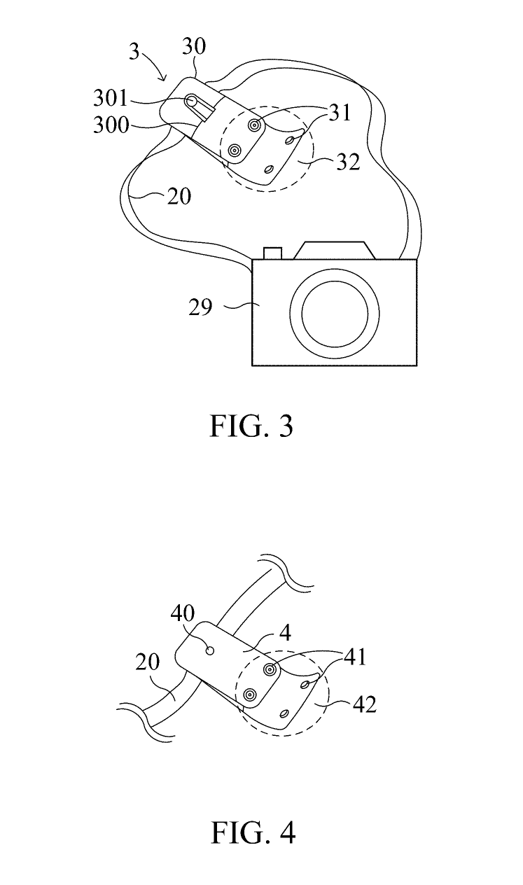

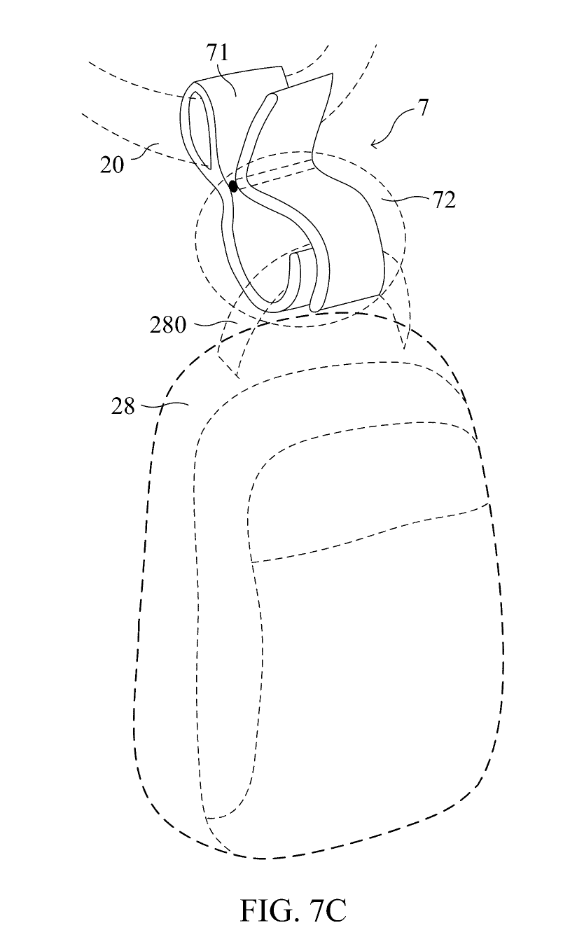

FIG. 3 schematically illustrates a neck strap structure according to an embodiment of the present disclosure. As shown in FIG. 3, a first end of the auxiliary member 3 has a first collar 30. The detailed structure of the first collar 30 may also be referred to the collar as shown in FIG. 7A. The first collar 30 allows the neck strap body 20 to pass through. Consequently, the auxiliary member 3 can be sheathed around the neck strap body 20 and slid along the neck strap body 20 without being detached from the neck strap body 20. Moreover, in case that the auxiliary member 3 is in a non-usage state, the auxiliary member 3 can be slid to any position where the user is not adversely affected. For example, the auxiliary member 3 may be moved to the position near the junction between the neck strap body 20 and the camera 29. A second end of the auxiliary member 3 has a second collar 32, which is formed by one or more sets of snap fasteners 31 attaching the ends of the second collar 32. The second collar 32 acts as the above-mentioned detachable fastening element. That is, the second collar 32 is coupled to the handle 280 of the double-shoulder backpack 28. Consequently, the stress originally applied to the user's neck will be diverted to the loaded object. Optionally, a pocket-type accommodation space 300 is formed on the first collar 30. The pocket-type accommodation space 300 is used for accommodating a small object such as memory card. Moreover, a protective buckling element 301 is further located at the mouth part of the pocket-type accommodation space 300 in order to prevent the small object from falling out of the pocket-type accommodation space 300 unintentionally.

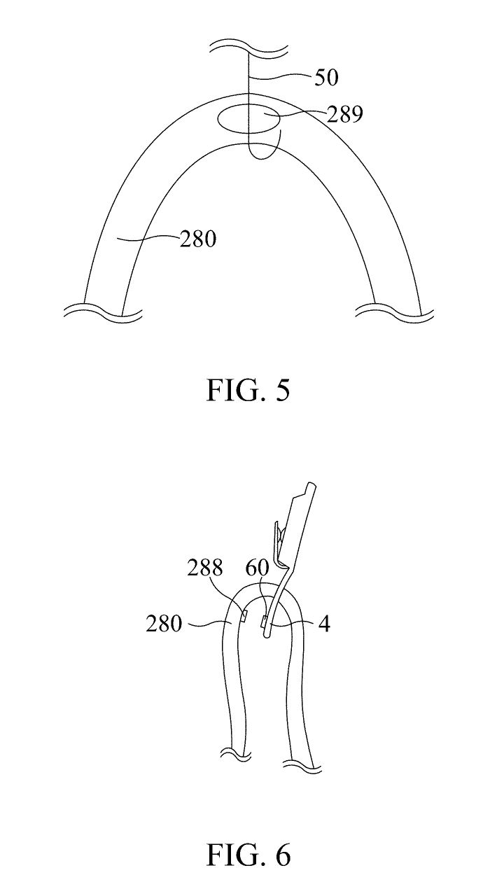

FIG. 4 schematically illustrates a neck strap structure according to a second embodiment of the present invention. As shown in FIG. 4, a first end of the auxiliary member 4 is directly fixed on the neck strap body 20 and not slidable. For example, the first end of the auxiliary member 4 is directly fixed on the neck strap body 20 by a stitching means, a gluing means or a snap-fit means, or the first end of the auxiliary member 4 is integrally formed with the neck strap body 20. Moreover, as shown in FIG. 4, the first end of the auxiliary member 4 is fixed on the neck strap body 20 through one or more sets of snap fasteners 40. Similarly, a second end of the auxiliary member 4 has a second collar 42, which is formed by one or more sets of snap fasteners 41 attaching the ends of the second collar 42. The second collar 42 acts as the above-mentioned detachable fastening element. That is, the second collar 42 is coupled to the handle 280 of the double-shoulder backpack 28. Consequently, the stress originally applied to the user's neck will be diverted to the loaded object.

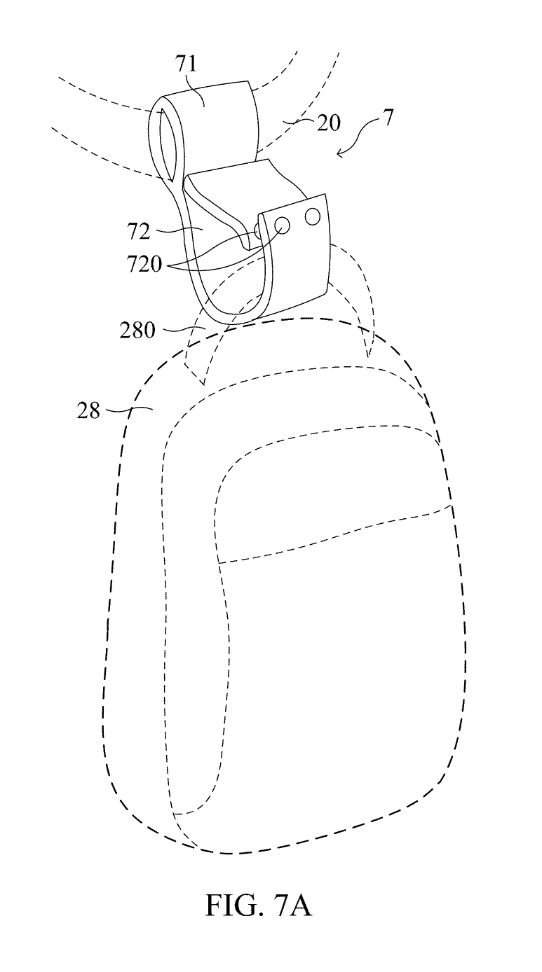

FIG. 5 schematically illustrates a neck strap structure according to a further embodiment of the present disclosure. In this embodiment, the detachable fastening element is a hook 50 or any other appropriate element. Moreover, the handle (or a hang ring) 280 has a structure mating with the hook 50. As shown in FIG. 5, the handle 280 (or the hang ring) has a perforation 289. After the hook 50 is penetrated through the perforation 289, the second end of the auxiliary member 4 is coupled with the handle 280 (or the hang ring).

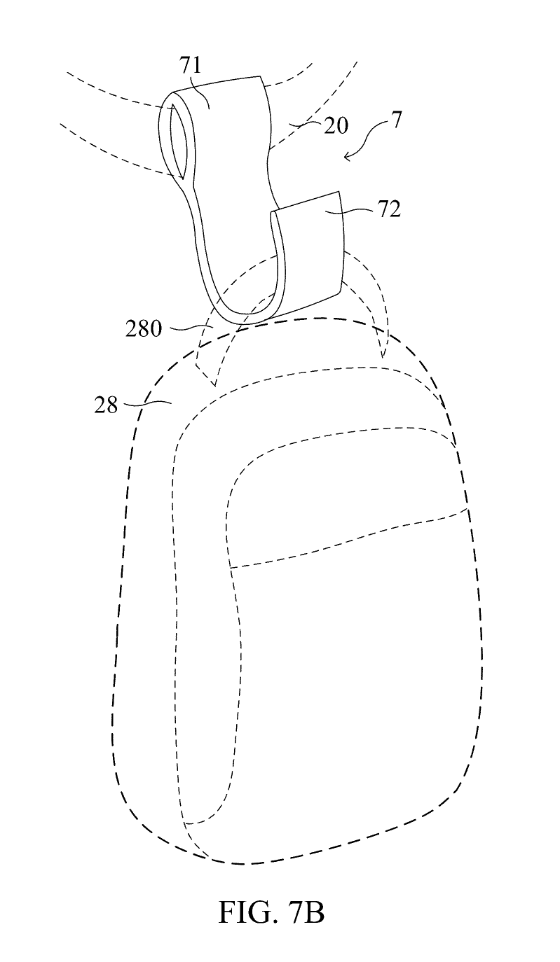

FIG. 6 schematically illustrates a neck strap structure according to a further embodiment of the present disclosure. In this embodiment, the handle (or the hang ring) 280 has a snap fastener part 288, and the second end of the auxiliary member 4 has another snap fastener part 60. Due to the engagement between the mating snap fastener parts 288 and 60, the second end of the auxiliary member 4 is coupled with the handle (or the hang ring) 280.

FIGS. 7A˜7C schematically illustrate some other examples of the neck strap structure according to the present disclosure. As shown in FIG. 7A, a first end 71 of the auxiliary member 7 is a collar, which is coupled to and sheathed around the neck strap body 20. A second end 72 of the auxiliary member 7 is a detachable collar, which is detachably coupled to the handle (or the hang ring) 280 through one or more sets of movable snap fasteners 720. In comparison with FIG. 7A, the second end 72 of the auxiliary member 7 is a curvy hooking structure for holding the handle (or the hang ring) 280. Since the second end 72 of the auxiliary member 7 is pulled down by the weight of the backpack 28 and the neck strap body 20 is also pulled down by the weight of the camera, the backpack 28 and the camera can be easily connected with each other or easily detached with each other. In the embodiment of FIG. 7C, the second end 72 of the auxiliary member 7 is a hook with a latch to catch the handle (or the hang ring) 280. In another embodiment, the second end 72 of the auxiliary member 7 is an elastic clipping structure that can clamp the handle (or the hang ring) in a fast and simple manner.

In the above embodiments, if the second end of the auxiliary member can slide along the handle 280 of the backpack 28, the position on the handle 280 where the second end of the auxiliary member is coupled changes with the relative position between the neck strap body 20 and the handle 280 of the backpack 28. Therefore, after the second end of the auxiliary member is coupled to the handle 280 of the backpack 28, the second end of the auxiliary member will slide to a proper position automatically. The user need not manually adjust the coupling position.

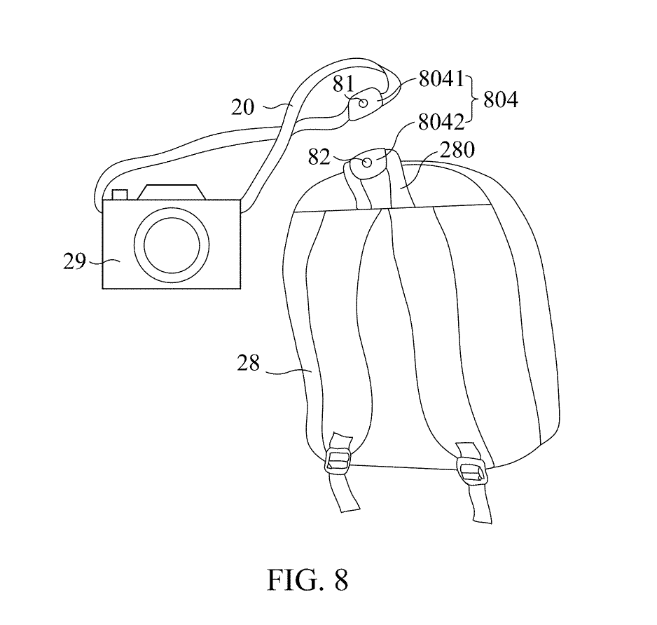

FIG. 8 schematically illustrates a neck strap structure according to a further embodiment of the present disclosure. In the embodiment, the auxiliary member 804 is modified. The auxiliary member 804 includes two separate auxiliary parts 8041 and 8042. The first auxiliary part 8041 is connected to the neck strap body 20, and the second auxiliary part 8042 is detachably coupled to the loaded object such as the double-shoulder backpack 28. The first auxiliary part 8041 may be connected to the neck strap body 20 as the first end of the auxiliary member connected to the neck strap body 20 described in the above embodiments. The second auxiliary part 8042 is coupled to the handle 280 of the double-shoulder backpack 28 before the user wears the double-shoulder backpack 28. For example, the second auxiliary part 8042 is coupled to the handle 280 or other similar part (e.g. a hang ring or a hook) of the double-shoulder backpack 28 by a detachable fastening element (e.g. snap fasteners) as described with reference to FIG. 4. The second auxiliary part 8042 is bent around a specific portion of the handle 280, and two ends of the second auxiliary part 8042 are connected together and fixed by coupling the snap fasteners on the two ends. The second auxiliary part 8042 may or may not slide along the handle 280. The first auxiliary part 8041 includes a first magnetic fastener 81, and the second auxiliary part 8042 includes a second magnetic fastener 82. After the first auxiliary part 8041 is connected to the neck strap body 20 and the second auxiliary part 8042 is coupled to the handle 280 of the backpack 28, the mating portions of the first magnetic fastener 81 and the second magnetic fastener 82 can face toward each other. The polarity direction of the first magnetic fastener 81 and the second magnetic fastener 82 is arranged to make the two magnetic fasteners 81 and 82 to attract each other by a magnetic force.

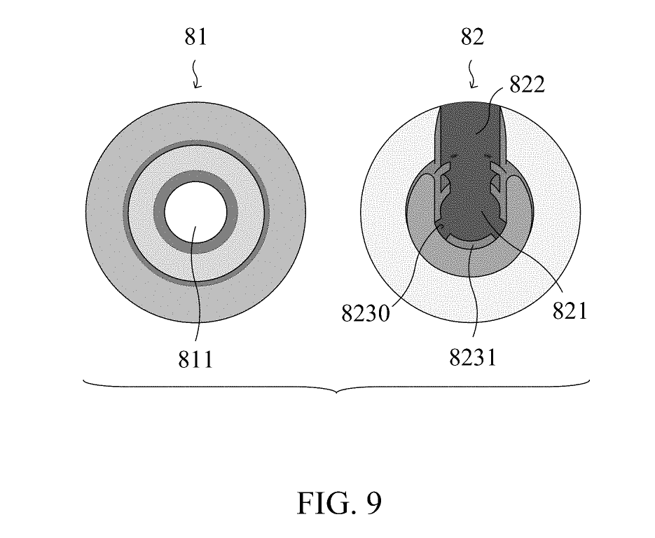

As shown in FIG. 9, the magnetic fasteners 81 and 82 may be a pair of magnetic snaps. The first magnetic fastener 81 is a male fastener having a central protrusion 811, and the second magnetic fastener 82 is a female fastener having a central recess 821 corresponding to the central protrusion 811. The central protrusion 811 may has a circular profile. When the first magnetic fastener 81 of the first auxiliary part 8041 is close to the second magnetic fastener 82 of the second auxiliary part 8042, the central protrusion 811 automatically slides into the central recess 821. The second magnetic fastener 82 further has a groove 822 connected to the central recess 821. If the central protrusion 811 falls in the groove 822, the central protrusion 811 will be attracted to move toward the central recess 821 along the groove 822 due to magnetic force and gravity. Therefore, the user need not align the mating parts in precise position, and the close mating parts can be attached together automatically.

Several engaging parts 8231 may be formed on the inner wall 8230 of the central recess 821 of the second magnetic fastener 82 to be engaged with the central protrusion 811 of the first magnetic fastener 81 so that the pair of the magnetic fasteners 81 and 82 are secured firmly. In another embodiment, the diameter of the central recess 821 is slightly smaller than the diameter of the central protrusion 811 so that the central protrusion 811 can be firmly fixed in the central recess 821. Under these conditions, an external force is required to press the magnetic fasteners 81 and 82 to attach them or pull apart the magnetic fasteners 81 and 82 to detach them.

The first magnetic fastener and the second magnetic fastener may be replaced by at least a pair of snap fasteners. For example, the first auxiliary part 8041 includes a male snap fastener (not shown), and the second auxiliary part 8042 includes a corresponding female snap fastener (not shown). In another embodiment, the first auxiliary part 8041 includes a female snap fastener, and the second auxiliary part 8042 includes a corresponding male snap fastener. Thus, the user has to attach the pair of snap fasteners together manually.

From the above descriptions, the present disclosure provides a neck strap structure having an auxiliary member. The auxiliary member can be widely applied to a neck-hanging article such as a camera or a telescope. Consequently, the stress originally exerted by the neck strap body 20 will be diverted from the user's neck to the user's body where the neck strap body 20 and the two shoulder straps of the double-shoulder backpack 28 are in contact with. In such way, the discomfort of carrying the neck-hanging article can be effectively alleviated. Hence, the neck strap structure of the present disclosure is industrially applicable.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A neck strap structure supporting an article and used with a loaded object having at least one shoulder strap, comprising:
a neck strap body having a contact part, wherein two ends of the neck strap body are connected to the article; and
an auxiliary member comprising a first auxiliary part and a second auxiliary part separate from the first auxiliary part,
the first auxiliary part being coupled to the contact part of the neck strap body and comprising a first fastener,
the second auxiliary part being detachably coupled to the loaded object, and comprising a second fastener corresponding to the first fastener.

2. The neck strap structure according to claim 1, wherein the first auxiliary part of the auxiliary member is fixed on the neck strap body by a stitching means, a gluing means or a snap-fit means, or the first auxiliary part of the auxiliary member is integrally formed with the neck strap body.

3. The neck strap structure according to claim 1, wherein two ends of the first auxiliary part are connected together to surround the contact part of the neck strap body, and the first auxiliary part is slidable along the neck strap body.

4. The neck strap structure according to claim 1, wherein the loaded object has a hang ring or a handle, wherein the second auxiliary part of the auxiliary member is detachably coupled to the hang ring or the handle.

5. The neck strap structure according to claim 4, wherein two ends of the second auxiliary part are connected together to surround a portion of the hang ring or the handle, and the second auxiliary part is slidable along the hang ring or the handle.

6. The neck strap structure according to claim 1, wherein the first fastener and the second fastener are magnetic fasteners which attract each other.

7. The neck strap structure according to claim 6, wherein the first fastener is a male magnetic fastener, and the second fastener is a female magnetic fastener.

8. The neck strap structure according to claim 7, wherein the female magnetic fastener has a groove connected to a central recess of the female magnetic fastener.

9. The neck strap structure according to claim 1, wherein the first fastener is one of a male snap fastener and a female snap fastener, and the second fastener is the other one of the male snap fastener and the female snap fastener.

10. A neck strap structure supporting an article and used with a backpack having a handle, comprising:
a neck strap body having a contact part, wherein two ends of the neck strap body are connected to the article; and
an auxiliary member, wherein a first end of the auxiliary member is coupled to the contact part of the neck strap body, and a second end of the auxiliary member is detachably and slidably coupled to the handle of the backpack.

11. The neck strap structure according to claim 10, wherein the first end of the auxiliary member is fixed on the neck strap body by a stitching means, a gluing means or a snap-fit means, or the first end of the auxiliary member is integrally formed with the neck strap body.

12. The neck strap structure according to claim 10, wherein the first end of the auxiliary member has a first collar, and the first collar is slidably coupled to the contact part of the neck strap body.

13. The neck strap structure according to claim 12, wherein the first end of the auxiliary member has at least one set of snap fasteners to make ends of the first collar to be attached together to form the first collar at the first end of the auxiliary member.

14. The neck strap structure according to claim 10, wherein the second end of the auxiliary member has a second collar, which is formed by attaching ends of the second collar via one or more sets of snap fasteners.

15. The neck strap structure according to claim 10, wherein the second end of the auxiliary member has a hook slidably catching the handle of the backpack.

16. The neck strap structure according to claim 10, wherein the second end of the auxiliary member has a hook with a latch, wherein the hook slidably catches the handle of the backpack.
